(19) United States
(12) Patent Application Publication
(10) Pub. No.: US 2005/0276180 A1
(43) Pub. Date: Dec. 15, 2005

(54) Data processing apparatus

(75) Inventors: Kouji Fujita, Yokohama (JP); Hiroaki Ono, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/058,122

(22) Filed: Feb. 14, 2005

(30) Foreign Application Priority Data
Jun. 11, 2004 (JP) 2004-173380

(51) Int. Cl. G11B 5/09; G11B 7/00

(52) U.S. Cl. 369/47.1; 369/59.1; 369/124.01

(57) ABSTRACT

There are cases where image contents with a limited number of copies allow data transfer although not dubbing operations. Transfer of temporarily recorded data from a recording medium such as a hard disk to a recording medium such a DVD-R raises a problem of erasing hard disk data for transfer even in case of incomplete data transfer. The disclosure of the present invention therefore describes determination means for determining a result of data transfer based on a condition for the transfer of the above-mentioned data allows a failure in data transfer to be prevented. This eliminates a concern over erasing HDD data for transfer during an incomplete data transfer.

### CROSS-REFERENCES TO RELATED APPLICATIONS

The present application is related to and claims priority from Japanese Patent Application No. 2004-173380, filed Jun. 11, 2004, and is hereby incorporated by reference for all purposes.

### BACKGROUND OF THE INVENTION

The present invention relates to a data processing apparatus for transferring data among recording media.

As shown in Japanese Patent Laid-open No. 2001-101790, some personal computers transfer data when its contents are fully verified, because they are personal computers.

There are video recorders which record image and music data and the like subjected to digital compression with MPEG (Moving Picture Expert Group) on hard disks and optical recording disks. Hard disks have large capacities (300 to 500 GB, for example). Despite their advantage of reproducing data at high speeds (20 GB/second, for example), these hard disks have limit of recording capacities and are fixed media that are not removable, thus forcing hard disk data to be erased periodically or backed up as required.

On the other hand, optical recording disks have some demerits such as smaller capacities (e.g., 4.7 GB for DVDs) than hard disks. Since, however, they are removable media and low-priced recording media, optical recording disks are infinite as storage libraries. Hybrid video recorders have recently been on the market as products having these two recording media incorporated in one recording unit.

The hybrid video recorder is capable of selectively dubbing temporary hard-disk image and music contents into the optical recording disk.

In many cases, recording media including hard disks and optical recording disks allow data errors in the recording and reproduction of image and music data. Unlike data such as data in computers, image and audio data characteristically suffer slight image and audio degradation or short-time (few-frame) image disturbance due to some data errors in some cases but no problems such as inability to reproduce images and sounds. As described above, methods for recording and reproduction despite of data errors (stream recording and reproduction) are widely used for digital recording of images and sounds.

A hard disk is a uniquely determined recording medium that determines recording characteristics and the recording characteristics are best tuned to the recording medium. Thus, recording and reproducing data causes data errors with a low probability.

However, an optical recording disk (hereinafter called as a DVD-R, but not limited to this) requires tuning recording and reproducing characteristics for each recording since a DVD-R is removable. Thus, a DVD-R suffers from data errors with a higher probability than a hard disk, due to problems with the accuracy of the above-mentioned tuning and wide differences among characteristics specific to recording media.

When hard-disk image and audio data temporarily recorded are copied to such a DVD-R, the data will be dubbed with many data errors. If the data errors are determined as terrible enough to raise viewing- or listening-related problems, a failure in copy will result. The allowable range of the above-mentioned data errors differs from user to user in terms of image data.

For image data copying, there are more and more image contents that do not allow a single session of copy from the viewpoint of copyrights or image contents that restrict the number of copying sessions. It is thought that there will be cases where such contents allow data transfer although not dubbing operations.

However, applying incomplete data transfer from a hard disk to a DVD-R as described above will raise a problem of erasing hard-disk data from which some data is transferred.

### BRIEF SUMMARY OF THE INVENTION

According to one aspect of the present invention, a data processing apparatus using a first recording medium and a second recording medium comprises means for transferring data from the first recording medium to the second recording medium, means for setting a data transfer condition, and means for determining a result of data transfer based on the data transfer condition, wherein data transfer is performed using a result of the determination means.

In an embodiment of the present invention, there is provided the above-mentioned data processing apparatus wherein the data transfer condition is switch input means for which a logic is set by means of a user's operation and wherein the determination means allows data to be transferred when a logic signal inputted by the switch input means is true.

In addition, the second recording medium is a removable recording medium, the data processing apparatus is provided with ejection means for discharging the removable recording medium, and the data transfer is completed with a discharge of the removable recording medium.

According to another aspect of the present invention, a data processing apparatus using a first recording medium and a second recording medium comprises means for transferring data from the first recording medium to the second recording medium, means for setting a data transfer condition, and data erasing means for erasing data of the first recording medium, and determination means for determining a result of data transfer based on the data transfer condition, wherein the data transfer is performed and data of the first recording media is erased by using the result of the determination means.

In the above-mentioned data processing apparatus, the data transfer condition is switch input means for which a logic is set by means of a user's operation, and the determination means allows data to be transferred when a logic signal inputted by the switch input means is true.

The second recording medium is a removable recording medium, the data processing apparatus is provided with ejection means for discharging the removable recording medium, and the data transfer is completed with the discharge of the removable recording media.

The data processing apparatus comprises verifying means for detecting a data comparison state between transferred data in the second recording medium and data to be transferred from the first recording medium and a detection result of the data comparison state is used for determination by the determination means.

In the above-mentioned data processing apparatus, a verification result is notified to a user as a data transfer success rate.

In the above-mentioned data processing apparatus, means for setting a data transfer condition is data transfer success rate setting means for presetting the data transfer success rate, and the data transfer success rate that is a data transfer condition and the detection result of the data comparison state by the verifying means are used for determination by the determination means.

The data processing apparatus comprises means for attaching a data transfer mark to the data at each predetermined data length.

According to a further aspect of the present invention, a data processing apparatus using a first recording medium and a second recording medium comprises means for attaching a data transfer mark to data in the first recording medium for each time length, means for transferring the data containing the data transfer mark to the second recording medium, data transfer mark setting means for setting or resetting the data transfer mark, means for setting a data transfer condition, and determination means for determining a result of data transfer based on the data transfer condition, wherein data to be recorded is a digital image signal including time information and wherein the data transfer mark is set using a determination of the determination means.

In a further embodiment of the present invention, the data processing apparatus uses the determination by the determination means to erase the data according to a value of the data transfer mark.

In a further embodiment of the present invention, the data is digital image data and the data processing apparatus comprises means for storing position information on the second recording medium that contains data determined as inconsistent as a result of the data comparison and means for reading out the digital image data based on the position information.

The second recording medium is a removable recording medium composed of a data management unit and a data unit, the data processing apparatus comprises verifying means for detecting a data comparison state between transferred data in the second recording medium and data to be transferred from the first recording medium, and invalid data is overrecorded on the data management unit according to a state result of the data comparison.

According to the present invention, as described above, a highly reliable data processing apparatus is obtained which meets user needs.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an example of a configuration for performing data transfer according to a condition determination;

FIG. 2 is a block diagram showing an example of a configuration in which a user determines data transfer probability;

FIG. 3 is a block diagram showing an example of a configuration for performing data transfer provided that a removable recording medium to which data is transferred is discharged;

FIG. 4 is a block diagram showing an example of a configuration for erasing data that is to be transferred;

FIG. 5 is a block diagram showing an example of a configuration for determining and performing a data transfer;

FIG. 6 is a block diagram showing an example of a configuration in which a user can confirm a data error section to which data is copied in data transfer; and

FIG. 7 is a block diagram showing an example of a configuration for destroying and discharging data to which data is copied when data transfer fails.

### DETAILED DESCRIPTION OF THE INVENTION

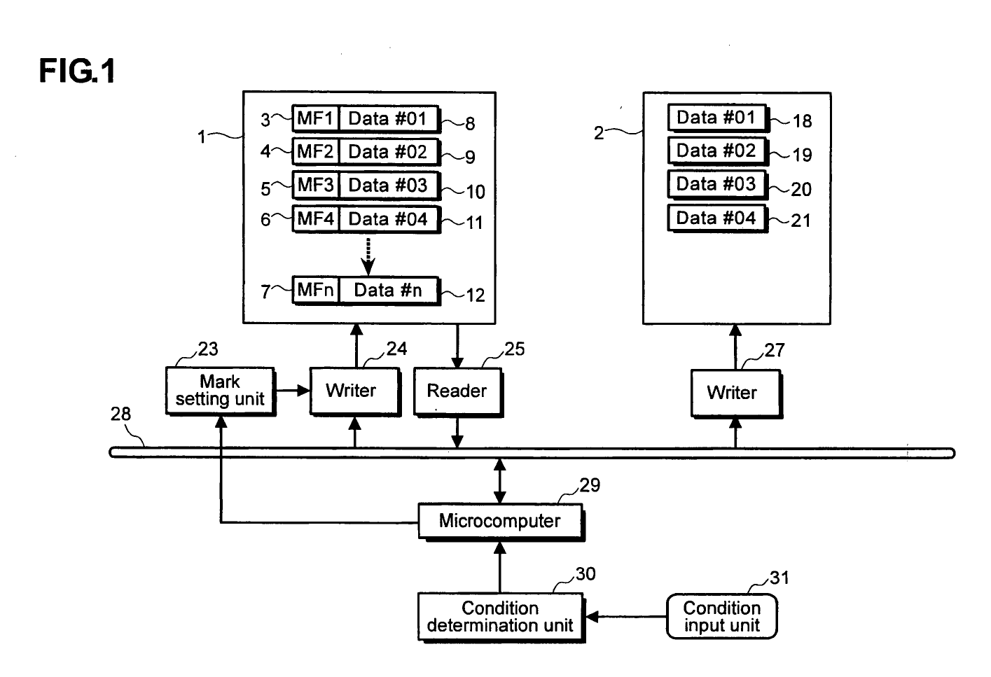

An example of a configuration of a data processing apparatus according to the present invention will be described below with reference to FIG. 1. The data processing apparatus is configured to transfer data to a first recording medium 1 (a hard disk, which is hereinafter referred to as a “HDD”) for accumulating and storing digital data such as image and music (hereinafter referred to as “AV data”) and a second recording medium 2 (an optical recording disk, which is hereinafter referred to as a “DVD-R”) for selectively accumulating and storing AV data in the HDD.

Note that the first recording medium and the second recording medium are for the description of the embodiment and not limited to the recording media described herein. The first recording medium and the second recording medium may be any type of recording medium such as a semiconductor memory and an optical disk.

The above-mentioned AV data is only for the description of the embodiment and not limited to AV data. The above-mentioned AV data may be any type of data. In addition, “data transfer” mentioned above will be described taking as an example data transfer from a HDD to a DVD-R. The direction of data transfer is never limited to the embodiment.

Particularly in AV data with its copyright protected, the number of data copies may be restricted or its reproduction may be made possible through reproduction permission, acknowledgement, or the like. In this case, however, the embodiment will also be applied to cases when AV data should be reproduced irrespective of data transfer.

A reference numeral 1 in FIG. 1 denotes an HDD, which has AV data stored. Although not shown in FIG. 1, AV data is content data such as image, audio, and the like which has been obtained from digital TV broadcasting or the Internet. AV data is divided into predetermined data lengths or predetermined data sizes. Or image data is divided into data blocks for a predetermined time: data #01, 8; data #02, 9; data #03, 10; data #04, 11; data and #n, 12. These data may be divided for every content or divisions for one content. For descriptive clarity, AV data for one content will be described herein with the data divided into fixed lengths of 2048 bytes.

A master flag (MF) data is made redundant for the above-mentioned data divided. The MF data is a state flag for each data block mentioned above. The MF data is set to each data block according to prescribed conditions. To make the operational description easy to understand, MF data is added herein to each data block. A data management region may be secured in a HDD not shown to set MF data to the data management region.

MF data 1 of a reference numeral 3, MF2 4, MF3 5, MF4 6, and MFn 7, show flags showing state management for data #01; data #02, data #03, data #04, and data #n, respectively. On the other hand, a DVD-R 2, to which data is to be transferred, consists of data #01 of a reference numeral 18, data #02 19, data #03 20, and data #04 21, none of which contain MF data. Data in the DVD-R 2 is data selected from the HDD 1.

An operation will be described below for transferring data from #01 8 to #04 11 from the HDD 1 to the DVD-R 2. Assume that four data blocks from data #01 8 to data #04 11 will be transferred. A microcomputer 29 transmits a readout command through a data bus 28 to a readout control section (reader) such that the reader reads data blocks, data from #01 8 to #04 11 out of the HDD 1. The reader reads data #01 to #04 from which MFs 1 to 4 are excluded out of the HDD 1 and delivers the data #01 to #04 to a data bus 28.

To record the data #01 to #04 on the data bus 28 in the DVD-R 2, the microcomputer 29 transmits a write-in command through a data bus 28 to a write-in control section (writer) and loads these data into the writer 27 in sequence.

In a mark setting unit 23, mark data showing that data #01 8 to data #04 11 have been transferred to the DVD-R 2 are then recorded in individual MFs corresponding to the data blocks in the HDD 1 which are to be transferred. For operative description, “00” and “FF” are, as mark data mentioned above, recorded for MF1 3 to MF4 6 in the relevant data blocks transferred and for other MFs n corresponding to the relevant data blocks not transferred, respectively.

The above operation allows mark data showing that data transferred has been done to be added to data blocks in the HDD 1.

The aforementioned mark data allows data manipulations such as data block erasing and data block readout inhibition in a lump according to the state of the mark data, for example, after data transfer to the DVD-R 2.

Note that mark data showing that data has been transferred need not necessarily be attached to data but may be managed, for example, by means of the memory in the microcomputer and the like, although attached to data in this embodiment.

A condition determination unit 30, which is important in this embodiment, will then be described below. The mark setting unit 23 records mark data in the MFs when data has been completely copied to from the HDD 1 to the DVD-R 2 for transfer. In this embodiment, however, the condition determination unit is further configured not to record mark data in the MFs unless conditions inputted from a condition input unit 31 are satisfied. Thus, simply moving a desired data block from the HDD 1 to the DVD-R 2 causes no change in MF mark data, i.e., no completion of data transfer.

The condition input unit 31 in FIG. 1 reads out and compares data #01 8 to data #04 11 (this operation is hereinafter referred to as “verification”) after these data are recorded in the DVD-R 2. Correct read-in is set as an input condition. The condition determination unit 30 determines from the result of the verification that there is no data error and delivers the result of determination to the microcomputer 29. The microcomputer 29 delivers a mark data recording command of MF to the mark setting unit 23. The mark setting unit 23 receives the command and sets “FF” to each of MFs 1 to 4.

As described above, providing a condition determination result that completes data transfer allows a failure in data transfer to be prevented. This helps greatly to eliminate a concern over the erasing or readout control of HDD data transferred during an incomplete data transfer.

An example of verification (complete data matching) has been described for the condition input unit 31 in the above embodiment. However, further great effect can be expected by changing the condition to the contents shown in an embodiment described below. A specific example of the condition input unit 31 will be described in detail in an embodiment shown below.

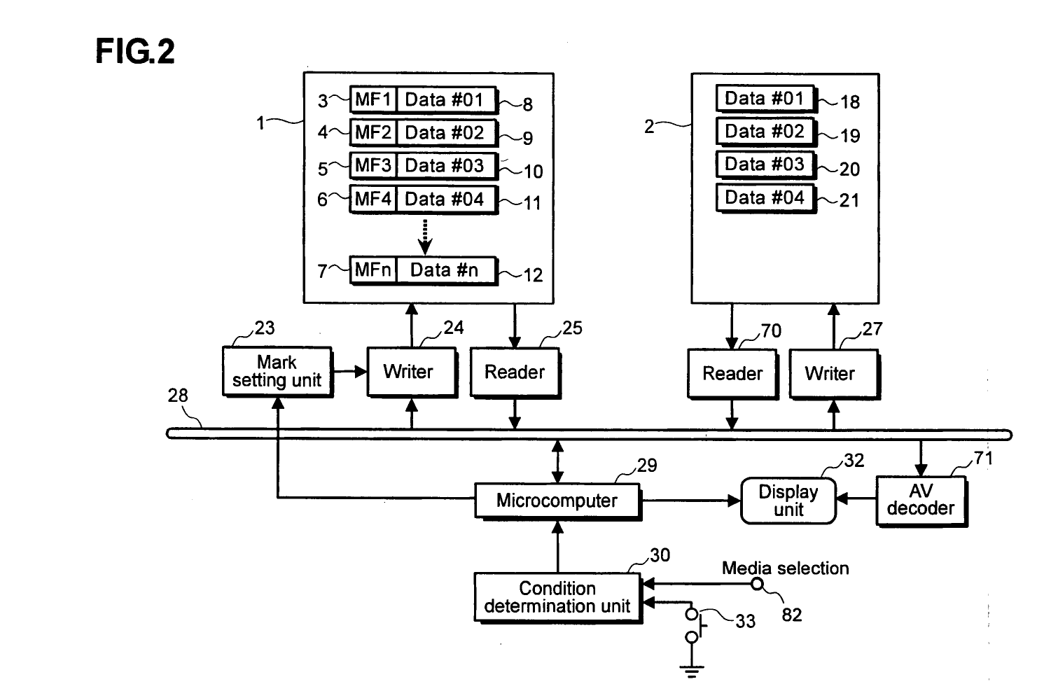

A specific example of the condition input unit will now be described with reference to FIG. 2. The same functional blocks as in FIG. 1 will not be described.

An expression “data transfer” will be used in the embodiment shown below. In case of data transfer, data is copied from a HDD to a DVD-R and copied data for DVD-R use is for example reproduced for checking purposes. If the HDD data is copied successfully, the HDD data is erased, thus completing data transfer. If the HDD data is not copied to the DVD-R successfully, a secure data transfer is realized, such as by making a display for prompting a recopy of the HDD data.

Operation for data transfer of data #01 8 to data #04 11 from a HDD 1 to a DVD-R 2 is the same as described above. The microcomputer 29 delivers a command to a reader 70 such that the aforementioned AV data transferred is read out of the DVD-R 2. The reader 70 reads out and delivers data #01 18 to data #04 21 to an AV decoder 71. The AV decoder 71 demodulates the AV data to an original image signal and displays an image on a display unit 32. A user can monitor the copied AV data to make sure that there is no problem with the AV data for data transfer use.

The user can also selectively monitor transferred data and data to be activated. A media selection signal is inputted from a media selection 82 to the microcomputer 29. If “HDD” is selected for media selection, the microcomputer delivers an AV data readout command to a reader 25 first and then data #01 8 to data #04 11 from a HDD to a data bus 28. The user can then view and listen to a master image of the transferred side by means of the AV decoder 71 and the display unit 32.

If, on the other hand, “DVD-R” is selected for media selection, the microcomputer 29 delivers an AV data readout command to a reader 70 first and then data #01 18 to data #04 21 from the DVD-R to the data bus 28. The user can then view and listen to a slave image to be transferred, by means of the AV decoder 71 and the display unit 32.

When the transfer of the data the user selected is over, the microcomputer 29 notifies the display unit 32 of data transfer completion display and requests the user to input a judgment for data transfer completion determination. As a result of his/her monitoring as described above, the user turns ON a determination switch 3 for data transfer completion, thus causing the condition determination unit 30 to deliver the result of condition determination to the microcomputer 29. The microcomputer 29 then delivers a signal for starting recording mark data in MFs to the mark setting unit 23. The operation following the above is the same as in the embodiment shown in FIG. 1.

The above configuration, setting the user's decision-making input as the above condition input, allows operation for data transfer to be completed. This helps greatly to eliminate a failure in data transfer.

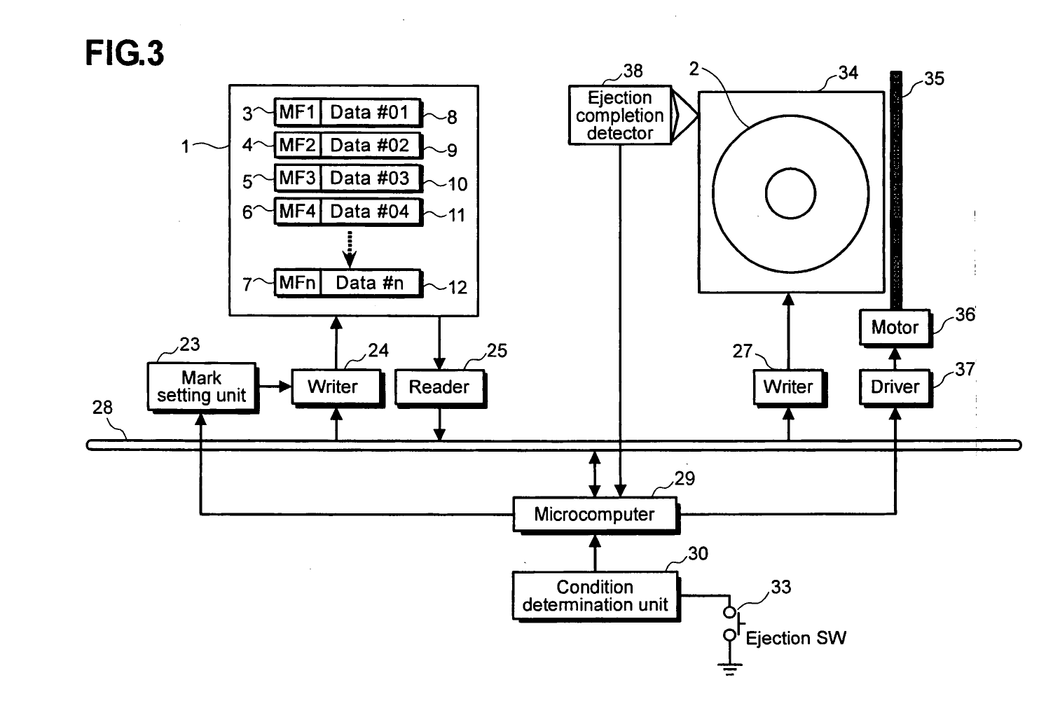

Another embodiment of the condition input unit will be described with reference to FIG. 3. The same functional blocks as in FIG. 1 will not be described.

Operation for copying data #01 8 to data #04 11 from a HDD 1 to a DVD-R 2 for transfer is the same as described above. FIG. 3 is an embodiment where operation for discharge completion is applied to the DVD-R 2.

Operation after the data transfer described above will be described with reference to FIG. 3.

The DVD-R 2 is a removable recording media and can be removed from the apparatus. With the DVD-R 2 not removed from the apparatus, a relevant AV data for transfer is present in the HDD 1 and the DVD-R 2, both of which are closed in a recording and reproduction unit. Removing the DVD-R from the apparatus will cause two AV data for transfer to be present in the HDD and the DVD-R independently. In this embodiment, therefore, the time when the user removes removable recording medium such as DVD-R from the recording and reproduction unit, by ejecting the DVD-R for example, is set as the data transfer condition mentioned above, after the AV data selected from the HDD 1 is transferred to the DVD-R 2.

The user turns “ON” an ejection switch 33. A condition determination unit 30 recognizes the start of an ejection operation and issues an ejection command to a microcomputer 29. The DVD-R 2 is carried by disk tray 34 and discharged and pulled through the rotation of a motor 36 and a lead screw mechanism 35. The microcomputer 29 delivers a command for rotating the motor 36 to a driver 37 to discharge the DVD-R 2. The motor 36 turns in a forward direction when the input of a motor driving signal inputted from the driver 37 followed by the discharge of the disk tray 34 and in a reverse direction when the disk tray 34 is pulled in.

An ejection completion detector 38 detects that the disk tray 34 has been discharged completely. A relevant detection signal is delivered to the microcomputer 29. When recognizing that the disk tray 34 has been discharged completely, the microcomputer 29 conveys mark setting timing to the mark setting unit 23. The mark setting unit messages a writer 24 to rewrite a MF data corresponding to a data to be copied for data transfer to the DVD-R 2 into “00”.

The above configuration allows MF data to be rewritten when a DVD-R is completely discharged. Processing can be performed to invalidate the readout of or erase data blocks corresponding to relevant “00” MF data. This helps greatly to realize complete data transfer.

A specific example for erasing or inhibiting the readout of data #01 8 to data #04 11 depending on the state of MF data will now be described in an embodiment shown below.

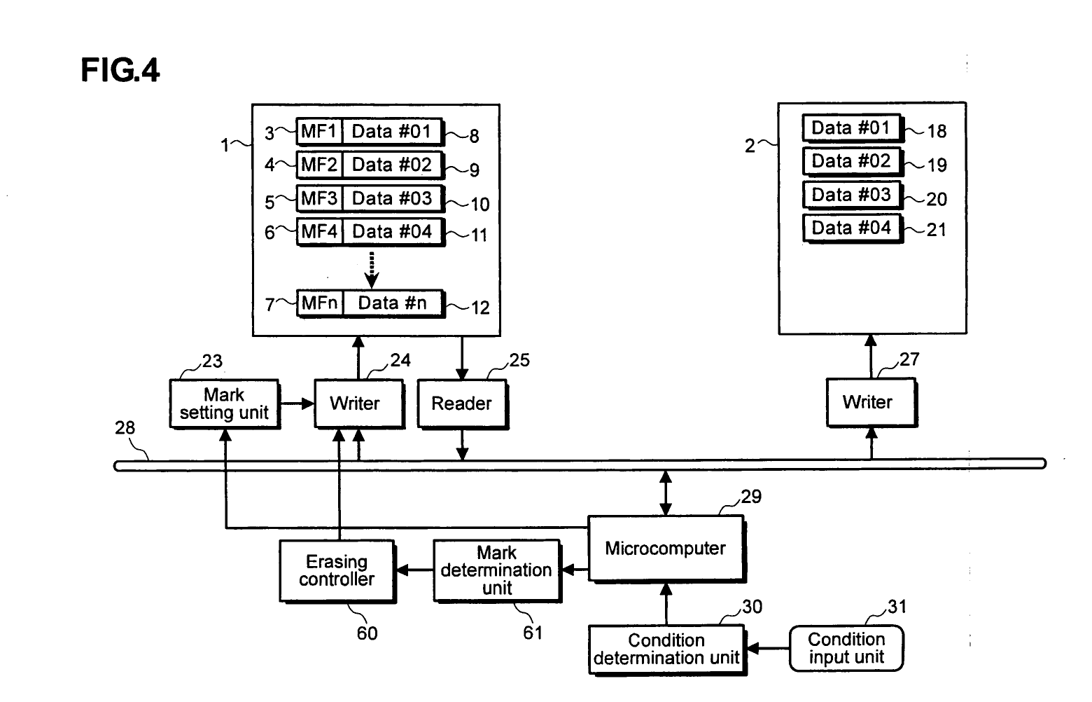

An embodiment for erasing the corresponding data according to a result of the determination of the first condition input unit and depending on the details of MF data values in the HDD 1 will be described with reference to FIG. 4. The same functional blocks as in FIG. 1 will not be described.

The microcomputer 29 transmits a command for reading MF data values through a data bus 28 to a reader 25. The reader reads all MF data in the HDD.

The microcomputer 29 loads and delivers MF data values to a mark determination unit 61 in sequence. The mark determination unit 61, if determining that MF data are “00”, transmits a data erasing command to an erasing controller 60 to erase data blocks corresponding to the MFs. The erasing controller 60 erases data blocks to be erased by overwriting the data blocks in a writer 24 with invalid data. Depending on the details of the MF data, the erasing of AV data corresponding to the MF data may be continued after the rewriting of the MF data.

In FIG. 4, four data blocks copied for transfer to the DVD-R 2 (data #01 18 to data #0, 21) correspond to data #01 8 to data #04 11 for copying for data transfer from the HDD 1. Copying operation for data transfer to the DVD-R 2 causes mark data “00” and “FF” to be set to MFs 1 to 4 and the other MF data, respectively, which is the same as in the embodiment shown in FIG. 3.

Because MF data value is “00” from MFs 1 to 4, the data blocks corresponding to MFs 1 to 4 (data #01 8 to data #04 11) are rewritten to invalid data such as “00”, for example. The erasing controller 60 rewrites data #01 8 to data #04 11 with mark data “00” set to their MFs to “00”.

The above configuration allows data for transfer to be erased according to the MF data after it is determined that the data for transfer is copied successfully. This helps greatly to complete data transfer from the HDD 1 to the DVD-R 2.

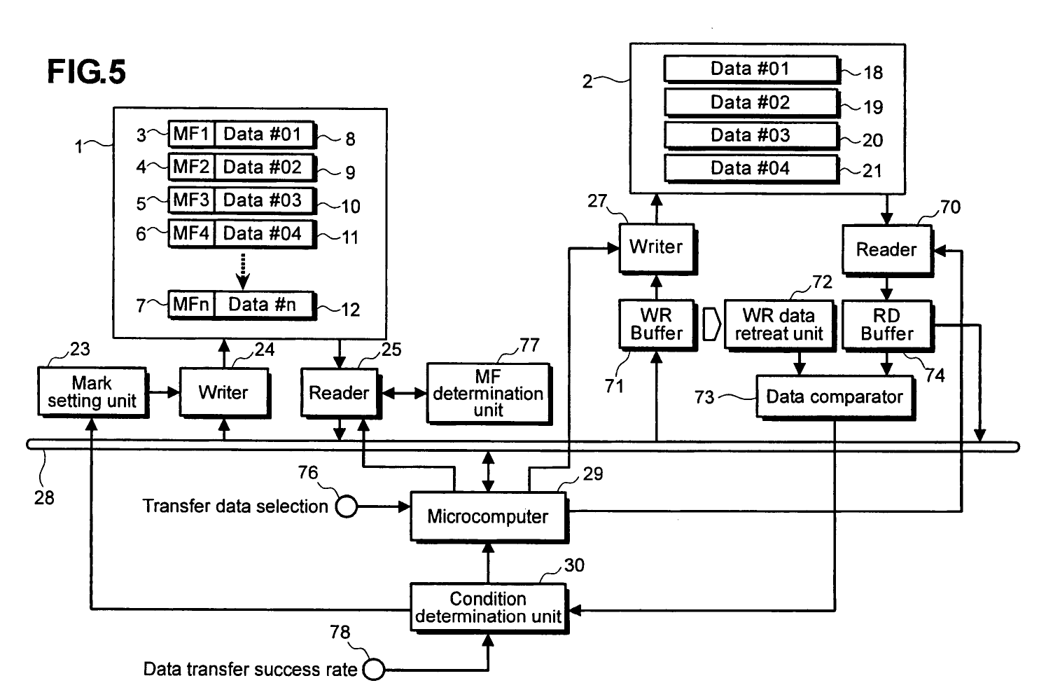

An embodiment for setting the first condition which is a result of a comparison between AV data for copying for transfer from a HDD 1 and AV data copied for transfer to a DVD-R 2 will then be described with reference with FIG. 5 in terms of operation.

This embodiment takes an example of a DVD-R as a recording medium for data copying for data transfer. Since, however, optical recording disks differ greatly in recording characteristics from maker to maker or from product lot to product lot, it can be said that there will be a great difference in recording quality. In other words, there is no guarantee that 100% of HDD data for copy for transfer will be recordable in a DVD-R to which the data will be copied for transfer. Most data errors can be relieved through the utilization of digital error correction technologies. However, there are cases where optical recording disks with particularly poor recording quality cannot be relieved through the utilization of the above-mentioned error correction technologies.

To ensure that desired AV data will be transferred from the HDD 1 to a low quality DVD-R and the like, data transfer success rate or a result of recording quality is notified to a user for judgment whether the rate or the result is a user's allowable range, and if it is determined as a user's allowable range, that is set as the first condition. Like data for personal computer use, the data transfer success rate for AV data is judged differently by different users. For data for personal computer use, 100% data transfer is essential while for AV data, such data transfer is not necessarily required and the data transfer success rate depends greatly on the allowable level of reproduced image quality.

FIG. 5 is a block diagram showing the configuration as described above. The same recording block as in FIG. 1 will not be described.

A user inputs AV data for transfer from a HDD 1 through a data transfer selection terminal 76 to a microcomputer 29. The microcomputer 29 transmits a data readout command to a reader such that selected HDD 1 data, data #01 8, data #02 9, data #03 10 and data #04 11, are read out.

The reader 25 reads out the four data blocks and determines the MF data values attached to the individual data blocks. If a result of determination shows that the data has already been transferred (MF data: “00”), a MF determination unit 77 performs readout control on the reader 25 such that the AV data is not outputted to a data bus 28. If, in addition, data has not yet been transferred (MF data: “FF”), the MF determination unit 77 permits the reader 25 to read out the AV data and the reader 25 delivers the AV data to the data bus 28.

In a DVD-R 2, to which data is transferred, the microcomputer 29 then temporarily reads the AV data from the HDD 1 into a writer buffer 71 at predetermined size length intervals. When data is accumulated to a prescribed size in the buffer, the microcomputer 29 delivers data to a writer 27 and records the data in the DVD-R 2 in sequence. When the microcomputer 29 finishes writing the data in the writer buffer 71, the data is temporarily stored in a WR data temporally storing unit 72.

To read the data written in out of the DVD-R 2, the microcomputer 29 then transmits a data readout command to a reader 70. The reader 70 reads the data written in out of the DVD-R 2 and temporarily accumulates the data in the reader buffer 74.

A data comparator 73 then makes a comparison between the data written in the WR data temporally storing unit 72 and the readout data in the reader buffer 74 and transmits a result of the comparison to the condition determination unit 30. The data comparator 73 compares all the AV data which are to be transferred from the HDD 1 to the DVD-R 2 at write-in data size intervals in sequence.

The user then inputs the data transfer success rate as the input condition through an input terminal 78. For example, a value of 100% is inputted into the condition determination unit 30. A data transferability efficiency is inputted from the data comparator. The condition determination unit 30 determines the data transfer success rate against a data transfer success condition using data transfer success information from the data comparator 73. For a result of the determination, a mark setting execution signal is transmitted to a mark setting unit 23 and a data transfer mark for the HDD 1 is set. The subsequent operation is the same as the embodiment shown in FIG. 4.

The above configuration allows data transfer from the HDD to the DVD-R to be completed due to a result of verification operation. The above configuration makes it possible to avoid a failure in data transfer in the case of a poor state of recording in the DVD-R. Note that the data transfer success rate inputted from the input terminal 78 may be equal to or smaller than 100% and that the rate may be in a user's allowable range depending on the level of quality of data transfer to the DVD-R.

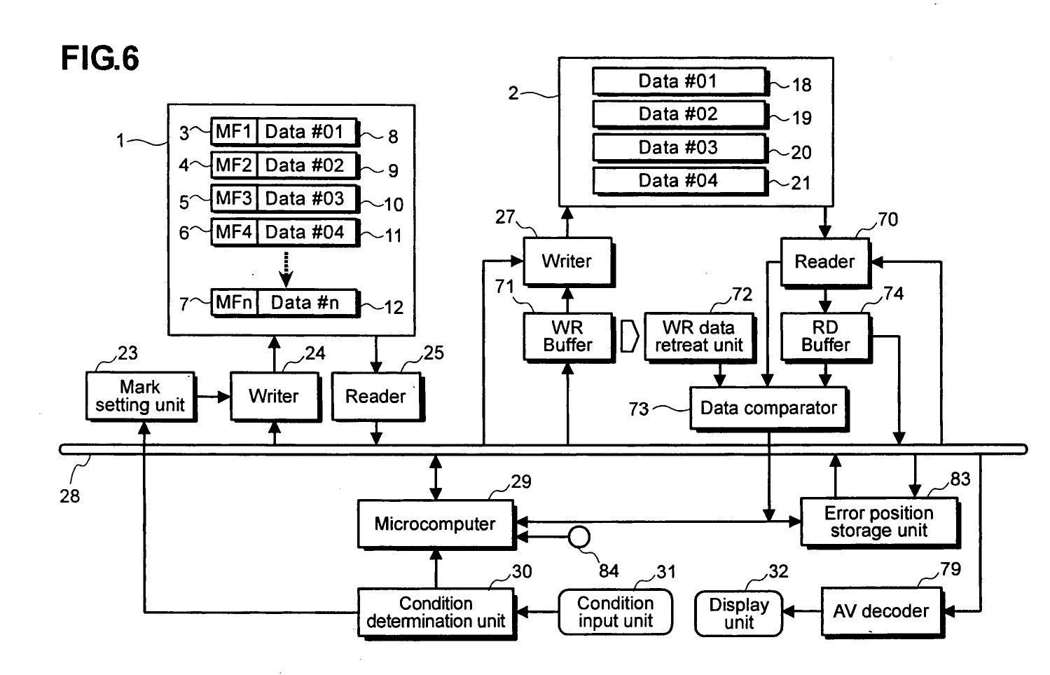

An embodiment for further improving the probability of a data transfer success rate will now be described with reference to FIG. 6. The same functional blocks as in FIG. 1 will not be described.

This embodiment is provided with a function for viewing and listening to the portion of AV data on a DVD-R which has been determined as inconsistent in the verification operation in the embodiment shown in FIG. 5. This embodiment is thus configured to make a user determine an allowable value for a data transfer success rate.

The data comparator 73 compares write-in data and readout data after writing in a DVD-R in the same way as described in the embodiment shown in FIG. 5. In this embodiment, however, position information (address) in the DVD-R is loaded for data determined as inconsistent. To realize this, the data comparator reads in an address corresponding to the data from a reader 70. Addresses for data determined as inconsistent are stored in an error position storage unit in sequence. Those addresses stored in sequence temporarily function as AV chapters.

An AV chapter is pointer information for image search, which serves to improve the searchability of an erroneous portion of AV data.

When finishing operation for transfer of selected data from an HDD to the DVD-R, the microcomputer 29 displays on a display unit position information on the DVD-R such as time for the chapter portion or thumbnail and waits for selected input. A user selects and inputs a data error chapter portion displayed on the display unit from an input terminal 84. Then microcomputer 29 then transmits a data readout command for an address portion corresponding to the chapter selected to a reader 70.

The reader 70 reads in data in the address portion, which is then inputted into an AV decoder 79 through a reader buffer 74 and a data bus 28. The AV decoder 79 demodulates and delivers the AV data as an original image signal to a display unit 32. The user can limit a portion that has failed to be transferred and checks images in sequence on the display unit 32.

If the user views and listens to portions indicated to have failed in transfer and determines that the portions are in an allowable range, the user inputs a data transfer completion input into a condition input unit 31. Operation following the relevant condition input is the same as the embodiment shown in FIG. 5.

According to this embodiment, as described above, a value for the data transfer success rate is notified to a user and the user evaluates data error portions with recovered state to image signals. This helps greatly to allow the user to determine a result of the data transfer success rate in more detail.

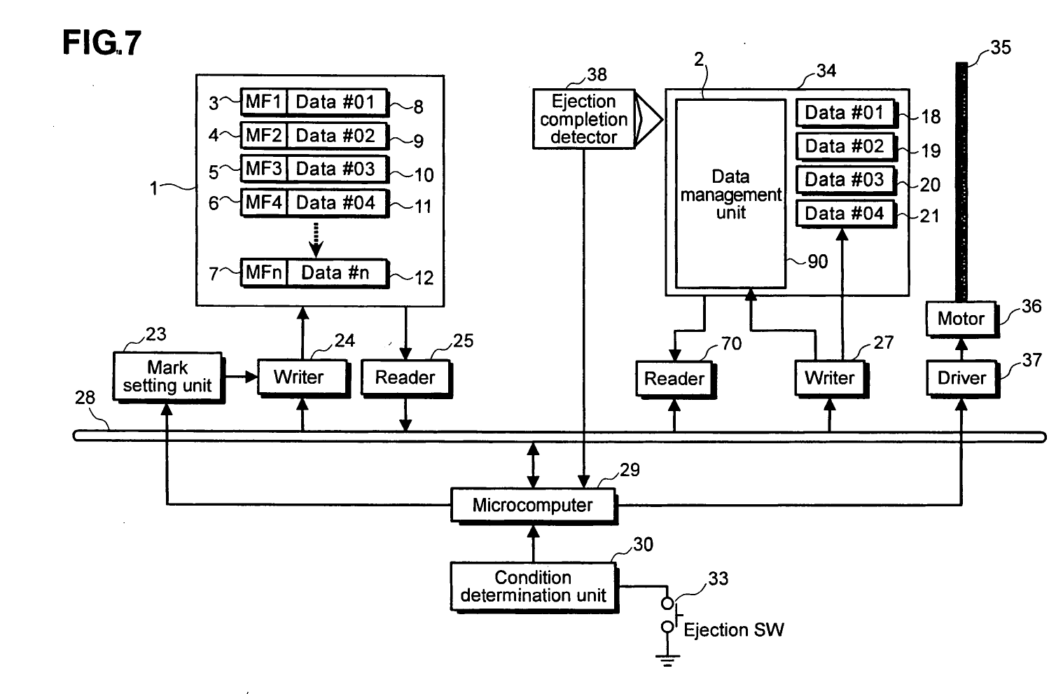

Operation for data transfer determined by a user as a failure in a result of the data transfer evaluation will be described with reference to FIG. 7. The same functional blocks as in FIG. 1 will not be described.

A data management region 90 in a recording medium will then be described below. A DVD-R 2 has a data region where AV data is recorded and a data management region where data-related information is recorded such as a recording start address, size, and individual data links for the data. For the data management region, erasing or destroying data makes it impossible to read the data out of the data region. The data construction mentioned above is the same for all recording media including DVD-Rs. The data construction, although not shown, is present in an HDD 1 as well. For HDDS, the data construction is not shown since no operational description for the data management region is required for HDDs.

Even if a user determines a relevant data transfer as a failure, HDD data, even if incomplete, has already been transferred to the DVD-R. If, therefore, the DVD-R is ejected, data contained in the DVD-R need to be erased or destroyed before DVD-R discharge.

Optical recording disks use laser beams to form optical marks on optical disks for data recording. The DVD-R is a special recording medium that allows data to written therein only once. This type of recording medium prevents data from being erased. Before the DVD-R is ejected, data contained in the DVD-R will therefore be destroyed. As an example of a method for destroying data, a writer 27 receives a DVD-R data destruction command from a microcomputer 29 and radiates higher beam rays than for normal recording onto a data management region for data destruction of the data management region.

After the end of the destruction of the data management region, the microcomputer 29 then transmits a data readout command to a reader 70. The reader 70 refers to a data management region 90 and recognizes that no data can be read out because data in the region is invalid or otherwise cannot be read out; i.e., “destroyed”. The reader then causes the microcomputer to determine that the DVD-R data is destroyed. The microcomputer 29 then determines that the DVD-R data is destroyed before ejecting the DVD-R.

Above example for a method for destroying data has is applied to a case where a recording medium is a DVD-R. For a rewritable optical recording disk, data in the data management unit 90 can be invalidated by overwriting the data in the data management unit 90 with invalid data. For example, all data in the data unit may be erased or destroyed without destroying or erasing data in the data management unit 90.

If data transfer fails, any method may be used if there is means available for invalidating data in a removable recording medium to which data will be transferred.

According to this embodiment, as described above, a DVD-R that suffers a failure in data transfer can be ejected after data in the DVD-R is completely destroyed. This helps greatly to prevent data outflow due to a DVD-R that contains data incompletely copied.

1. A data processing apparatus for transferring data from a first recording medium to a second recording medium, said data processing apparatus comprising:
a first interface configured for data communication with a first recording medium;
a second interface configured for data communication with a second recording medium;
a control unit in data communication with said first interface and said second interface, said control unit operable to transfer data between said first and second recording media via said first and second interfaces;
a memory storage to store a data transfer condition; and
a data processing device operative to perform a move operation to move data stored on said first recording medium to said second recording medium via said control unit by performing steps of:
reading first data from said first recording medium;
writing said first data to said second recording medium to create a copy of said first data thereon;
detecting when said data transfer condition has been met; and
when said data transfer condition has been met, then deleting said first data from said first recording medium in a manner that said first data cannot be recovered by operation of said control unit, thereby effecting a move operation of said first data.

2. The data processing apparatus according to claim 1, wherein if said data transfer condition is not met then said data processing device performs a step of deleting said copy of said first data from said second recording medium.

3. The data processing apparatus according to claim 1, wherein deleting said first data includes overwriting locations on said first recording medium where said first data is stored with data that is different from said first data.

4. The data processing apparatus according to claim 1, wherein deleting said first data includes creating invalid data at first locations on said first recording medium, wherein said control unit will produce an error result when attempting to read said first locations.

5. The data processing apparatus according to claim 1, wherein said data transfer condition is set by a user action.

6. The data processing apparatus according to claim 1, wherein said second recording medium is a removable recording medium, said data processing apparatus further comprising an ejection mechanism to effect a discharge operation of said removable recording medium, wherein said data transfer condition is met when a discharge operation of said removable recording medium completes.

7. The data processing apparatus according to claim 1, wherein said data processing device is further operative to compare said first data with said copy of said first data to produce a comparison result, wherein said comparison result is used to determine whether said data transfer condition is met or not met.

8. The data processing apparatus according to claim 7, wherein said first data is digital image data, the data processing apparatus further comprising a memory storage to store position information of second data blocks stored on said second recording medium, said second data blocks deemed to contain errors as determined by a comparison of said first data with said copy of said first data, said data processing device further operative to read out said second data blocks from said second recording medium using said position information.

9. The data processing apparatus according to claim 7, wherein said data transfer success rate is presented to the user.

10. The data processing apparatus according to claim 7, further comprising memory storage to store a predetermined data transfer rate, wherein said comparison result is based on a comparison of said predetermined data transfer success rate and a data transfer success rate of said reading said first data and said writing said first data.

11. The data processing apparatus according to claim 1, further comprising a mark setting unit to for attach a data transfer mark to data blocks comprising said first data.

12. The data processing apparatus according to claim 11 wherein each of said blocks of data is of a predetermined size.

13. A data processing apparatus using a first recording medium and a second recording medium, said data processing apparatus comprising:
means for associating a data transfer mark to each data block in a first set of data blocks stored on said first recording medium, the size of each data block being based on a predetermined length of time;
means for transferring said first data blocks to said second recording medium;
data transfer mark setting means for setting or resetting said data transfer marks;
means for setting a data transfer condition; and
determination means for producing a determination result of a data transfer based on said data transfer condition;
wherein data to be recorded is a digital image signal including time information and wherein said data transfer mark is set based on said determination result.

14. The data processing apparatus according to claim 13, wherein said determination result is used to determine whether to erase said first data blocks on said first recording medium according to a value of their associated data transfer marks.

15. A method for moving data from a first recording medium to a second recording medium comprising:
reading first data from a first recording medium;
writing said first data to a second recording medium to create a copy of said first data thereon;
detecting when a data transfer condition has been met, said data transfer condition being based on said steps of reading and writing; and
when said data transfer condition has been met, then deleting said first data from said first recording medium in a manner that said first data cannot be read from said first recording medium, thereby effecting a move operation of said first data.

16. The method according to claim 15, wherein if said data transfer condition is not met then deleting said copy of said first data from said second recording medium.

17. The method according to claim 15, wherein deleting said first data includes overwriting locations on said first recording medium where said first data is stored with data that is different from said first data.

18. The method according to claim 15, wherein deleting said first data includes creating invalid data at first locations on said first recording medium, wherein an error result is produced when attempting to read said first locations.

19. The method according to claim 15, wherein said data transfer condition is set by a user action.
